(19) United States
(12) Patent Application Publication
(10) Pub. No.: US 2026/0332025 A1
(43) Pub. Date: Oct. 22, 2026

(54) APPARATUS AND METHOD FOR OPERATING A SWITCHING POWER CONVERTER

(71) Applicant: Infineon Technologies Austria AG, Villach (AT)

(72) Inventors: Shi-Heng HONG, New Taipei City (TW); Alfredo MEDINA-GARCIA, München (DE); Tiam Poh LAU, Ottobrunn (DE); Gengsen CHEN, Shenzhen (CN)

(21) Appl. No.: 19/648,822

(22) Filed: Apr. 15, 2026

(30) Foreign Application Priority Data
Apr. 16, 2025 (DE) 102025114985.2

(51) Int. Cl. H02M 1/00; H02M 3/07; H02M 3/335

(52) U.S. Cl. CPC H02M 1/0035; H02M 1/0012; H02M 1/0095; H02M 3/07; H02M 3/33571; H02M 3/33592

(57) ABSTRACT

Provided is a controller for operating a switching power converter. The controller comprises a drive output configured to drive a power switch of the switching power converter; a current sense input configured to receive a current sense signal indicative of a current through the power switch; and control logic configured to detect a transition from a burst idle state to an active burst state of the switching power converter; in response to the transition, extend a leading-edge blanking (LEB) interval applied to the current sense signal for one or more switching cycles before reverting to a default LEB interval, and/or fix an on-time of the power switch for one or more switching cycles.

### RELATED APPLICATION

This application claims priority to German Patent Application No. 102025114985.2, filed on Apr. 16, 2025, entitled “APPARATUS AND METHOD FOR OPERATING A SWITCHING POWER CONVERTER”, which is incorporated by reference herein in its entirety.

### FIELD

The present disclosure relates to the field of power supplies and particularly relates to control methods and circuits for switching power converters operated in burst mode.

### BACKGROUND

Switching power converters are electronic circuits that convert electrical energy from one voltage level to another using a high-frequency switching element—e.g., a transistor—together with inductive or capacitive energy storage elements. They are widely used in modern power management systems due to their high efficiency and compact size.

In many applications, such as energy-efficient adapters and chargers for USB Power Delivery or LED lighting systems, power converters are required to operate efficiently even under low or no load conditions. To this end, so-called burst mode operation may be employed. Burst mode refers to an intermittent switching strategy where the converter alternates between periods of active switching (bursts) and idle periods. This technique helps to reduce switching losses and improve efficiency during light-load or standby conditions.

To enable operation during these idle phases, a controller of the converter must be supplied with power even when no continuous energy transfer takes place. This may be achieved using a charge-pump circuit, which is a type of DC-DC converter that uses capacitive charge storage and switching elements to generate a required supply voltage. Charge-pump circuits are particularly useful in scenarios where the input and output voltages vary significantly, as they can provide a relatively stable internal supply voltage without depending on transformer-based auxiliary windings.

Conventionally, charge-pump circuits may be used to fulfill the requirement for self-supply of the controller, especially in burst mode under low or no-load conditions. However, in combination with a current-controlled switching mode, problems can arise particularly during the transition from an idle state to an active burst operation: if a capacitor in the charge-pump circuit is not yet fully charged, this may lead to an excessive inrush current. This inrush current may be reflected through a current sense resistor and may cause premature shutdown of the main switch.

Such effects may result in an increased number of pulses in burst mode, insufficient energy delivery to the controller supply, and unwanted voltage spikes at secondary-side switches. In practice, this may not only reduce the efficiency during standby operation but also destabilize overall system behavior.

To suppress short-term current spikes, the state of the art typically employs a fixed so-called leading-edge blanking time (LEB), during which the current control is inactive immediately after the switch is turned on. However, this measure is often insufficient, as the LEB time must be kept short for reasons of control stability and thus cannot reliably mask inrush currents during burst start-up. At the same time, a general extension of the LEB time increases the risk of control errors during regular operating conditions.

Therefore, there is a need to provide control methods and circuits that enable a more robust and efficient handling of burst starts and in particular can reduce the influence of inrush-related current spikes, without impairing control stability during normal operation.

### SUMMARY

This need is addressed by apparatuses and methods in accordance with the independent claims. Further embodiments are addressed by the dependent claims.

According to a first aspect of the present disclosure, it is provided a controller for operating a switching power converter. The controller comprises a drive output that is configured to drive a power switch (e.g., a transistor) of the switching power converter. The controller comprises a current sense input that is configured to receive a current sense signal indicative of a current flowing through the power switch. The controller further comprises control logic that is configured to detect a transition from a burst idle state to an active burst state of the switching power converter and, in response to this transition, to extend a leading-edge blanking (LEB) interval applied to the current sense signal for one or more switching cycles before reverting to a default LEB interval, and/or to fix an on-time of the power switch for one or more switching cycles.

The present disclosure relates to a control strategy for switching power converters that operate in burst mode. The controller includes a drive output which controls the switching element responsible for energy transfer. It also includes a current sense input, which enables the controller to monitor the instantaneous current through the power switch. This current measurement may be used for implementing peak current mode control. A functionality of the controller lies in its ability to detect a transition from a passive state—where no switching occurs (the burst idle state)—to an active state in which energy pulses are again delivered (the active burst state). Upon such a transition, the controller either temporarily extends the duration of the blanking interval—during which current sensing is suppressed—to mask transient effects such as inrush currents, and/or it temporarily fixes the on-time of the power switch, thereby bypassing peak current control during the initial switching cycles. This adjustment may be automatically reversed after one or more switching cycles, allowing the system to return to its normal control behavior. The two measures—extending the blanking interval and fixing the on-time—can also be applied in combination, such that initial burst pulses are executed with a fixed on-time, followed by pulses during which an extended blanking interval is used, before normal current-based control is resumed.

This may help avoid undesired premature termination of the switch-on phase caused by transient inrush currents—such as those occurring when a charge-pump capacitor has not yet reached its steady-state level. By masking or overriding the current sense signal during the initial cycles after wake-up, the controller may allow more stable and reliable converter startup behavior in burst mode. As a result, energy delivery to the output and to internal supply rails can be improved, and potential instabilities caused by excessive current spikes may be mitigated. This can contribute to reduced power loss during standby operation and improve compliance with energy efficiency requirements.

In some embodiments, the control logic is configured to detect the transition from the burst idle state to the active burst state based on at least one of the following conditions: the duration of a preceding burst idle state, a measured supply voltage of the controller being below a threshold, or a predetermined time-out. A combination of these criteria may also be used. These are exemplary criteria that may be used to identify a wake-up event or the onset of an active burst phase. The duration of the idle period may serve as an indicator that internal supply components—such as charge-pump capacitors—have likely discharged to a degree that warrants special handling during the reactivation phase. Similarly, a direct measurement of the controller's supply voltage can reveal whether sufficient energy is available to perform standard peak current-based switching control, or whether transient effects such as inrush currents are to be expected. As a further option, the controller may use a predefined time-out to determine when to trigger the special burst handling routines. By relying on one or more of these detection criteria—individually or in combination—the control logic may more accurately anticipate situations in which transient disturbances such as inrush currents are likely to occur. This may allow the controller to selectively activate countermeasures, such as extended blanking or fixed on-time control, only when truly necessary. As a result, the system may achieve more robust and efficient burst-mode transitions while minimizing unnecessary deviations from standard operation.

In some embodiments, the control logic is configured to detect the transition based on a supply voltage of the controller reaching a predefined threshold. This refers to a way in which the controller may recognize the right moment to begin applying special control measures—such as fixed on-time or extended LEB—during the startup of burst mode operation. Specifically, the control logic may monitor the supply voltage that powers the controller itself. This voltage may be generated by a charge-pump circuit and may be stored on a capacitor. After a period of inactivity (burst idle state), this supply voltage can drop due to leakage or power-down behavior. When switching resumes, the capacitor must recharge, which can cause a brief but significant inrush current. If this inrush is not accounted for, it can interfere with normal current sensing and cause the controller to prematurely turn off the power switch. By detecting that the controller's own supply voltage is still below a predefined threshold, the control logic can determine that the supply has not yet stabilized and that transient effects (like inrush current) are likely to occur. As a result, the controller can temporarily override or modify its normal current-mode control—for example, by enforcing a minimum on-time or by extending the blanking interval during which the sensed current is ignored. This approach may allow the controller to respond adaptively to the actual internal supply condition, rather than relying only on time-based assumptions. This can make the startup behavior more robust and efficient, as the controller may apply protective measures only when they are needed, and avoids unnecessarily prolonging them once the supply has stabilized.

In some embodiments, the control logic is configured to emulate a magnetizing current based on a transformer winding voltage and a primary inductance. The control logic may be configured to compare a sensed current with the emulated magnetizing current and to ignore the sensed current for determining the on-time of the power switch when a deviation between the sensed and emulated current exceeds a threshold. This describes a control technique used to improve the reliability of current-mode control during the initial switching cycles after a burst idle phase. When a switching power converter resumes operation after a pause, the current sensed by the controller may be distorted by transient effects such as inrush currents caused by recharging a supply capacitor. These distortions can lead to incorrect or premature termination of the power switch conduction time. To mitigate this, the controller includes logic that emulates the expected magnetizing current—that is, the ideal current flowing through the transformer's primary winding under normal conditions. This emulation may be based on known electrical properties of the system, such as the voltage across the transformer winding and the inductance of the primary side. Using these parameters, the controller can calculate what the current should look like during the on-time of the power switch, assuming no disturbances are present. By comparing this emulated current to the actual sensed current, the controller can determine whether the sensed value is being affected by transient interference. If the deviation between the sensed and the emulated current exceeds a defined threshold, the controller may temporarily ignore the sensed current and will not use it to determine when to turn off the power switch. Instead, the switch remains on for a time determined by other control criteria, such as a fixed on-time or a calculated duration. An advantage of this is that it allows the controller to distinguish between valid switching current and unwanted transients, such as inrush events, without relying solely on time-based blanking. This may improve accuracy and reliability of the converter's operation during startup phases and helps maintain stable energy delivery while avoiding false overcurrent triggers.

In some embodiments, the control logic is configured to revert from the extended LEB interval or the fixed on-time to a peak current-based switching control after a predetermined number of burst pulses, after a predetermined duration has elapsed, or once a controller supply voltage exceeds a threshold. These embodiments relate to conditions under which the controller transitions back from the modified control mode—used during wake-up—to its regular peak current-based switching operation. The temporary nature of the measures is to avoid negatively impacting performance once the initial transient effects have subsided. By defining one or more exit conditions—such as a fixed number of executed burst pulses, the elapsing of a defined time interval, or the detection of a sufficiently high controller supply voltage—the control logic may ensure that the system returns to its standard operation mode in a controlled and timely manner. This may contribute to maintaining system efficiency and stability by confining the extended blanking or fixed on-time operation strictly to the time period during which such interventions are beneficial. Once the internal supply has stabilized and the inrush conditions have cleared, peak current-mode control can resume, enabling precise regulation of the energy transfer and maintaining the expected performance characteristics of the converter.

In some embodiments, the controller comprises a LEB circuit that is configured to apply a first LEB interval to the current sense signal upon turn-on of the power switch. The LEB circuit may comprise a timer that defines the first LEB interval. An extended LEB interval may be set by overriding the timer with a second, longer blanking value in response to the transition from the burst idle state to the active burst state. This provides an implementation option for the extended blanking functionality. The LEB circuit may be responsible for suppressing the current sense signal for a short duration immediately after the power switch is turned on, in order to ignore short transients such as switching noise or diode reverse recovery effects. In this embodiment, the default LEB interval is defined by a timer, and the extension of the blanking time—triggered upon wake-up—is achieved by temporarily overriding this timer with a longer interval value. Such a mechanism may allow for a flexible and efficient realization of dynamic blanking behavior without requiring fundamental changes to the current sense path. By modifying the timer-based blanking window in response to the detected transition, the controller may reliably suppress the effects of inrush current that would otherwise interfere with peak current detection. This may contribute to a smoother startup sequence and reduce the risk of erroneous switch-off events during initial burst pulses.

In some embodiments, the current sense input is configured to receive an inrush current drawn from a charge-pump supply circuit powering the controller. The extended LEB interval masks this inrush current from the current sense input during the one or more switching cycles following the transition from the burst idle state. This addresses a scenario encountered during the wake-up phase of burst mode operation, in which the charge-pump supply circuit that powers the controller may not yet have reached its steady-state voltage. As a result, the initial recharging of the charge-pump capacitor can generate an inrush current that flows through the main power switch and is sensed at the current sense input. If unmasked, this transient current may be misinterpreted by the control system as an overcurrent condition, potentially causing premature switch-off. By applying an extended blanking interval during the affected switching cycles, the controller may suppress the erroneous influence of such inrush currents. This may allow the power converter to complete the initial energy transfer cycles without unnecessary interruption, thereby improving the robustness of burst mode startup and supporting stable and efficient system behavior.

In some embodiments, the controller comprises a minimum on-time circuit that is configured, in response to the transition from the burst idle state to the active burst state, to maintain the power switch on for at least a set duration regardless of the current sense signal. This relates to a mechanism that may ensure a minimum energy delivery during the initial switching cycles following wake-up. By enforcing a fixed minimum on-time for the power switch, independent of the sensed current, the controller may prevent premature termination of the switch-on phase due to transient conditions such as inrush currents or insufficient initial supply voltage. The use of a minimum on-time circuit may be particularly beneficial when the controller supply relies on charge-pump circuits that require a brief period of sustained conduction to recharge. By ensuring that the switch remains on long enough to allow sufficient energy transfer, the system may stabilize more quickly after burst idle periods. This may contribute to a smoother transition into normal operation and reduce the risk of entering undervoltage conditions or unstable switching behavior.

In some embodiments, the control logic is configured to adapt the fixed on-time based on a measured input voltage or a supply voltage of the controller, such that a longer on-time is applied under lower voltage conditions. This may provide a refinement of the fixed on-time concept, allowing the controller to dynamically adjust the duration of the switch-on phase in response to actual operating conditions. When the measured input voltage or the internal supply voltage of the controller is low—such as may occur immediately after a burst idle period—the fixed on-time is extended to compensate for the reduced energy transfer capability during those conditions. By modulating the on-time in this way, the controller may deliver sufficient energy to charge internal supply components or support the output stage even under suboptimal voltage levels. This behavior may help to avoid premature switch-off events and ensure a more reliable wake-up process. It may also reduce the likelihood of triggering undervoltage lockout or control loop instability, thereby contributing to more robust and adaptive system performance in burst mode operation.

In some embodiments, the controller further comprises a feedback interface configured to receive a signal indicative of an output voltage or an auxiliary winding voltage. The control logic may be configured to vary at least one of a number of pulses in a burst, an on-time of each pulse, or a pause duration between bursts in response to the feedback signal. This may provide a mechanism for closed-loop control during burst mode operation by incorporating feedback from the power converter's output or auxiliary winding. By monitoring such a signal, the controller may dynamically adjust key switching parameters—such as how many pulses are included in a burst, how long each pulse is active, or how long the converter remains idle between bursts—in order to more accurately meet the system's load or voltage regulation requirements. The ability to adapt burst characteristics based on real-time feedback may enable finer control over output stability, reduce voltage ripple, and improve overall power conversion efficiency. Moreover, this adaptive behavior may help to maintain compliance with strict power delivery specifications, especially in systems with variable load conditions or wide input/output voltage ranges.

In some embodiments, the control logic is configured to combine an extended LEB interval and a fixed on-time within the same wake-up sequence. Initial burst pulses may utilize a fixed on-time and subsequent burst pulses may utilize an extended blanking interval, or vice versa. This may provide a coordinated control approach that leverages the benefits of both fixed on-time and extended blanking in a time-staggered sequence. During the first few switching cycles following a transition from the burst idle state, the controller may enforce a fixed on-time to ensure adequate energy transfer and prevent early switch-off due to inrush-related disturbances. In the cycles that follow, the controller may maintain peak current mode control but continue to suppress transient effects through an extended blanking interval. By combining these two measures in a structured sequence, the controller may achieve a gradual and controlled transition back to normal operation. This may reduce the risk of instability during burst wake-up and improve the reliability of power delivery, particularly in systems where supply voltages or load conditions can vary significantly. The staged application of these mechanisms may also help to optimize the trade-off between control precision and transient immunity.

According to a further aspect of the present disclosure, it is provided a method of controlling a power converter in burst mode. The method includes providing a drive signal for operating a switching element in the burst mode following a sleep period of the power converter. The method includes receiving a sense signal indicative of current flowing through the switching element of the power converter. The method includes identifying a wake-up condition indicative of a charge-pump circuit being in an uncharged state. The method further includes, in response to identifying the wake-up condition, performing at least one of extending a LEB interval applied to the sense signal for one or more switching cycles before reverting to a default LEB interval, and/or fixing an on-time of the switching element for one or more switching cycles. This aspect of the disclosure relates to a method that may be implemented in hardware, firmware, or software to manage the wake-up behavior of a power converter operating in burst mode. The method includes detecting the wake-up phase that follows a sleep period, during which the internal supply—typically maintained by a charge-pump circuit—may have discharged. The detection of this wake-up condition may trigger either the temporary extension of the LEB interval to mask transient inrush currents or the application of a fixed on-time to ensure stable energy delivery. The described method may allow for improved control flexibility and robustness during burst startup. By conditionally modifying switching behavior only when a wake-up scenario is detected, the converter may avoid the negative effects of supply instability or transient current spikes. This may contribute to enhanced power efficiency, reduced stress on switching components, and better compliance with low standby power requirements.

The wake-up condition may be identified using an auxiliary voltage sensed directly by the controller, or by comparing a measured current signal with an emulated magnetizing current. These techniques may allow the controller to distinguish between actual load demand and transient inrush effects, enabling improved startup behavior and enhanced adaptability.

According to yet another aspect of the present disclosure, it is provided a computer program, stored on a non-transitory computer-readable medium, comprising instructions which, when executed by a microcontroller, cause the microcontroller to provide a drive signal for operating a switching element in burst mode following a sleep period of a power converter; receive a sense signal indicative of current flowing through the switching element of the power converter; monitor a wake-up condition associated with a charge-pump circuit; and, in response to identifying the wake-up condition, perform one of extending a LEB interval applied to the sense signal for one or more switching cycles before reverting to a default LEB interval, and/or fixing an on-time of the switching element for one or more switching cycles. This aspect of the disclosure describes a software-based implementation that may enable a microcontroller to perform the method previously described. The computer program includes instructions that allow the system to manage the converter's burst mode behavior in response to a detected wake-up condition. The program logic may include functionality for driving the switching element, monitoring the current through it, and selectively modifying the control strategy during initial burst pulses based on the charge-pump's state. By embedding such instructions in a non-transitory storage medium, the described control strategy may be flexibly deployed across various hardware platforms. This may allow the control behavior to be updated, tuned, or ported without changes to the underlying circuitry. The software-based nature of the solution may contribute to improved adaptability, reduced design complexity, and faster development cycles, while still enabling effective handling of wake-up transients and enhancing the reliability and efficiency of burst mode operation.

According to yet another aspect of the present disclosure, it is provided an apparatus for controlling a power converter. The apparatus comprises a transformer having at least one primary winding and at least one auxiliary winding magnetically coupled to the primary winding. The apparatus comprises a charge-pump circuit configured to generate a supply voltage for a controller from the auxiliary winding. The apparatus comprises a switching element coupled between the controller and the primary winding and configured to selectively enable or interrupt current flow through the primary winding during operation of the power converter. The apparatus comprises a current sensing arrangement configured to provide a sense signal representative of a current flowing through the switching element. The apparatus comprises the controller configured to operate the switching element in a burst mode after a sleep period, detect a wake-up condition indicative of the charge-pump circuit being in an uncharged state, and, in response to the wake-up condition, extend a LEB interval of the current sensing arrangement during one or more switching cycles before reverting to a default LEB interval, and/or fix an on-time of the switching element for one or more switching cycles.

This apparatus integrates both the hardware topology and the functional behavior needed to realize the burst mode control strategy. The inclusion of a magnetically coupled auxiliary winding enables the generation of an internal supply voltage through a charge-pump circuit, which supports controller operation during idle or low-load phases. The current sensing arrangement allows for real-time monitoring of the switching element, enabling precise control based on current flow. The controller is designed to recognize when the system transitions from a sleep state to active burst operation, particularly in situations where the supply voltage may be temporarily insufficient due to an uncharged charge-pump capacitor. In response, the controller may adjust the switching strategy by applying either a fixed on-time or an extended blanking interval, or both, during the critical initial switching cycles. This integrated approach may provide a compact and effective solution for minimizing unwanted switching interruptions, improving power delivery reliability during wake-up, and maintaining high overall efficiency in burst mode applications.

In some embodiments, the controller is configured to extend the LEB interval only for a predetermined number of initial switching cycles following the wake-up condition, and to revert to the default LEB interval automatically after the predetermined number of cycles has elapsed. This embodiment may provide a time-or cycle-limited application of the extended blanking behavior to avoid prolonged deviation from standard current mode control. By applying the extended blanking interval selectively and temporarily—limited to a known number of initial switching cycles—the controller may suppress the effects of transient inrush currents during the most critical moments of wake-up, while ensuring that the system quickly returns to its normal operating behavior. Such a configuration may help to balance robustness during the wake-up phase with responsiveness and precision during steady-state operation. It may also reduce the risk of long-term masking of legitimate overcurrent conditions, thereby preserving protection functions and enabling efficient and safe power conversion.

In some embodiments, the controller is configured to track elapsed time from the wake-up condition and revert to the default LEB interval when either a predefined number of switching cycles or a time threshold is reached. This embodiment may provide an additional or alternative mechanism for limiting the duration of the extended blanking interval. By monitoring not only the number of switching cycles but also the elapsed time since the wake-up condition was detected, the controller may apply more flexible criteria for returning to default operation. This dual-trigger mechanism—based on either time or switching activity—may allow the system to respond appropriately under varying conditions, such as different load levels or supply ramp-up times. The ability to use time-based and cycle-based thresholds in parallel may enhance the robustness and predictability of the control strategy, ensuring that the extended blanking interval remains active only as long as necessary. This may contribute to improved protection, increased control accuracy, and better adaptation to diverse operating environments.

In some embodiments, the controller is configured to measure the supply voltage associated with the controller, and to extend the LEB interval whenever the supply voltage is below a threshold at the time of the wake-up condition. This embodiment may provide a condition-based approach for activating the extended blanking behavior, using the internal supply voltage as an indicator of system readiness. A supply voltage below a defined threshold at the time of wake-up may signal that the charge-pump capacitor is not yet sufficiently charged, increasing the likelihood of inrush currents that could interfere with current sensing. By linking the activation of the extended blanking interval to this voltage condition, the controller may apply transient suppression measures only when they are likely to be needed. This targeted application may improve the overall efficiency and responsiveness of the control strategy, while minimizing unnecessary intervention during wake-up phases where the internal supply is already stable. Such a configuration may also support reliable startup behavior and reduce the risk of triggering undervoltage lockout or erratic switching behavior.

In some embodiments, the controller is configured to restore the default LEB interval once the supply voltage of the controller exceeds the threshold, or after a defined number of switching cycles has elapsed. This embodiment may define the conditions under which the controller exits the extended blanking mode and returns to standard current sensing operation. By monitoring whether the internal supply voltage has risen above a defined threshold, the controller may determine when the effects of the initial inrush current have subsided and normal operation can resume. Alternatively, the return to the default blanking interval may be triggered after a fixed number of switching events, providing a predictable and bounded extension period even if the supply voltage remains below the threshold. This approach may allow the control logic to dynamically adapt its behavior during startup or reactivation, while ensuring that temporary measures like extended blanking are not applied longer than necessary. As a result, the system may maintain accurate current regulation, avoid unnecessary masking of fault conditions, and improve overall control efficiency and system stability.

In some embodiments, the controller is configured to adapt the fixed on-time based on at least one of a measured input voltage to the power converter, the supply voltage for the controller indicating the charge level of a supply capacitor, or an indication of output load conditions. This embodiment may allow the controller to dynamically adjust the duration of the fixed on-time in response to changing electrical conditions within the system. A lower input voltage, a low supply voltage derived from the charge-pump circuit, or a high output load may all indicate that more energy needs to be delivered during each switching cycle to ensure stable operation. By increasing the fixed on-time under such conditions, the system may more reliably support internal power needs and output demands during the critical wake-up phase. This adaptability may help to ensure that the converter maintains sufficient energy transfer capacity even under unfavorable operating conditions. It may also contribute to smoother recovery from idle states, better handling of variable loads, and enhanced protection against undervoltage events or premature switching interruptions during burst mode startup.

In some embodiments, the charge-pump circuit comprises at least one capacitor that is at least partially discharged during the sleep period. The controller may be configured to detect the discharge state of said capacitor as part of the wake-up condition. This embodiment may provide a means for directly assessing the energy state of the charge-pump circuit, which supplies the controller with operating voltage during burst mode. Since the charge-pump capacitor may lose charge during extended idle periods, its voltage level can serve as a reliable indicator of whether transient effects such as inrush current are likely to occur upon reactivation. By detecting the discharge state of the capacitor, the controller may make informed decisions about whether to initiate measures such as extended blanking or fixed on-time. This condition-based approach may enhance the precision of the wake-up handling strategy, ensuring that control interventions are only applied when warranted by the actual state of the power supply. As a result, system efficiency and responsiveness may be improved while reducing unnecessary delays in returning to peak current-controlled operation.

In some embodiments, the controller is configured to revert from the extended LEB interval or the fixed on-time to a peak current-based switching control after a predetermined number of burst pulses, after a predetermined duration has elapsed, or once the supply voltage for the controller exceeds a threshold. This embodiment restates and generalizes the conditions under which the controller transitions back to standard current mode operation following a wake-up phase. It may include cycle-based, time-based, and voltage-based criteria, offering multiple options for determining when the system has stabilized sufficiently to resume normal control behavior. The flexibility to choose from or combine these criteria may allow the system to adapt to different power supply architectures, application environments, or operating profiles. By reverting to peak current mode control once the relevant threshold has been reached—whether in time, pulse count, or voltage—the controller may ensure both protection and efficiency. This may prevent unnecessary extension of transient-mitigation measures and support accurate current regulation, stable power delivery, and compliance with performance and safety requirements across a wide range of operating scenarios.

The controller according to the present disclosure may be implemented as a microcontroller that is configured to control a switching power converter. In such an embodiment, the microcontroller may execute software or firmware instructions that generate drive signals for a power switch, monitor current and voltage signals, and apply control algorithms that govern burst mode operation, including the timing and duration of switching events. The microcontroller may include integrated analog and digital circuitry—such as analog-to-digital converters, comparators, timers, and memory blocks—that enable it to perform real-time signal acquisition and decision-making. For example, it may evaluate a sensed current signal from the power stage, measure internal or external supply voltages, and determine whether specific wake-up conditions are met. Based on such evaluations, the microcontroller may initiate measures such as extending a LEB interval or applying a fixed on-time for a limited number of switching cycles. Implementing the controller as a microcontroller may allow for high flexibility and configurability, enabling system designers to adapt the control behavior to various converter topologies, load profiles, or energy efficiency requirements. Furthermore, the software-based nature of such a controller may facilitate updates, parameter tuning, and diagnostic capabilities, making it a practical and scalable solution for modern power management applications.

### BRIEF DESCRIPTION OF THE FIGURES

Some examples of apparatuses and/or methods will be described in the following by way of example only, and with reference to the accompanying figures, in which

FIG. 1 illustrates a high-level block diagram of a controller configured to operate a switching power converter in burst mode;

FIG. 2A shows a timing diagram highlighting premature switch-off caused by inrush current during burst mode wake-up;

FIG. 2B compares converter behavior before and after applying fixed on-time or extended LEB at burst wake-up;

FIG. 3 depicts a method flowchart for controlling a power converter in burst mode, including detection of wake-up conditions and application of transient handling measures;

FIG. 4 illustrates a circuit diagram of an apparatus including a controller, switching element, transformer, auxiliary windings, current sensing, and charge-pump supply; and

FIG. 5 shows a detailed schematic of the charge-pump circuit and highlights how capacitor charging current can affect current-mode control.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

Power converters are electronic devices or circuits that convert electrical energy from one form to another, tailoring it to the needs of a specific load. They may employ semiconductor switches (transistors, diodes) and energy storage elements (inductors, capacitors) to modulate voltage and current. By rapidly switching an input power on and off (often at high frequency), converters can step voltage levels up or down or change DC to AC and vice versa. Common examples include AC-DC rectifiers, DC-DC regulators (buck, boost, flyback, etc.), DC-AC inverters, and AC-AC frequency changers. These circuits are ubiquitous in modern electronics—from phone chargers and computer power supplies to renewable energy systems—because they can provide efficient power delivery and control, ensuring devices receive stable and optimized voltage/current.

Burst mode operation is a control technique used in power converters to improve efficiency at light loads or no-load conditions. Instead of switching continuously at a fixed frequency (which can waste power when the load demand is very low), the converter intermittently halts switching to save energy. In burst mode, the controller may deliver power in short bursts of switching pulses, then enters a pause (sleep) phase with the switch off until output voltage or current needs a refresh. During the active burst, the converter may produce a group of pulses at normal operating frequency, followed by an idle period where many internal circuits may enter a low-power state. This on/off pulsing may reduce an average switching frequency and quiescent losses, cutting standby power consumption. For example, a regulator might switch for a few cycles to charge the output up to an upper threshold, then stop switching until the output naturally discharges to a lower threshold—a form of controlled hysteresis. The trade-off is a slightly larger output voltage ripple and potential EMI at the burst frequency, but in return the standby efficiency is greatly improved. Burst mode control may be used to meet strict standby power regulations and to extend battery life in portable devices.

A charge-pump circuit is a type of DC-DC converter that uses capacitors as energy storage elements to step voltages up or down in discrete increments. Instead of inductors (as in buck/boost converters), charge pumps rely on capacitor charging and discharging cycles controlled by switches to transfer charge and achieve the desired output voltage. In operation, a capacitor may be alternately connected to a supply (to charge) and to the output (to transfer charge), often with the help of diodes or transistor switches directing the current. Because they require only capacitors and switching devices, charge pumps may be simple and compact, making them suitable for on-chip voltage converters or bias supply circuits. They can attain high efficiency (often 90-95% in practice) while avoiding magnetic components. Common applications of charge pumps include generating higher voltages for flash memory programming, creating negative supply rails (e.g. −5 V from +5 V for analog circuits), or powering the gate drive of high-side transistors in buck converters. In offline or wide-input power converters, a charge pump may be used as a controller's self-supply (V_{CC}) circuit. For instance, in designs with a wide range of output voltage (such as USB PD adapters from 5 V to 48 V out), using an auxiliary winding tied to the output can be problematic because the controller's supply voltage would vary with the output. Instead, a charge pump from a primary switching node can provide a more stable V_{CC} by tapping energy directly from the input or switching element. This approach may reduce a voltage stress on linear regulators and may ensure the controller gets sufficient supply across operating conditions. Charge-pump based supplies may thus be significant in power electronics for enabling wide-range operation and compact design. However, they may introduce design considerations—notably, a need to manage capacitive charging currents that occur when starting or resuming operation, which can affect converter behavior (as will be seen in the disclosed subject matter below).

The present disclosure aims to improve burst mode control in a switching power converter by addressing an energy shortfall and disturbances caused by a controller's charge-pump supply when waking from a burst-off period. In simple terms, the present disclosure proposes inserting a special on-time control phase at the beginning of a burst (after the converter wakes from a sleep interval) to temporarily override or augment a normal current-mode control. This may ensure the first one or few switching pulses deliver sufficient energy despite any transient conditions, thereby compensating for insufficient power delivery that would occur if standard current limiting were applied immediately in burst mode. By doing so, the converter can avoid multiple tiny pulses and instability on burst wake-up, achieving more consistent burst behavior. Stated succinctly, the proposed concept is: when a converter exits burst (idle) mode, momentarily modify the switching control (e.g. extend the switch on-time beyond the normal current limit cutoff) to account for the charge-pump capacitor's effect, then return to normal control.

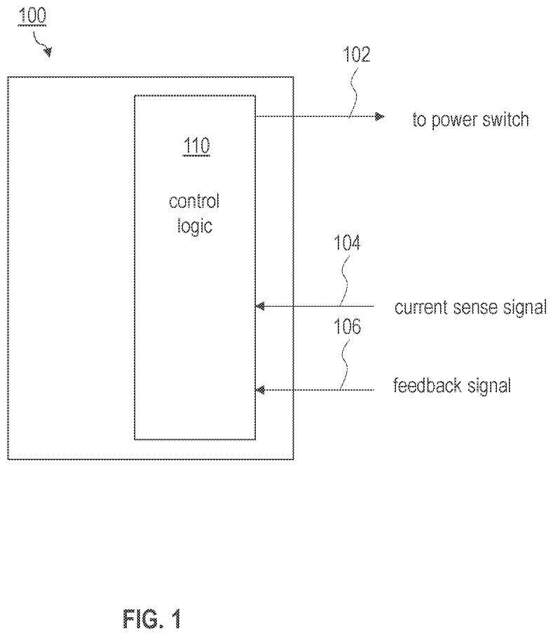

FIG. 1 illustrates a high-level block diagram of a controller 100 that is configured to operate a switching power converter (not shown).

The controller 100 comprises a drive output 102, a current sense input 104, one or more optional feedback interfaces 106, and an internal control logic block 110. The control logic 110 is shown as a sub-block within the controller 100, indicating that it may form part of the internal functional structure of the controller 100.

The controller 100 may be implemented in various forms depending on the requirements of a target application. In one example, the controller 100 may be realized as a dedicated integrated circuit (IC) specifically designed for switching power converter control. Such an implementation may include analog front-end circuits for current and voltage sensing, digital logic for state management, and output drivers for controlling external power switches. Alternatively, the controller 100 may be implemented using a microcontroller that executes firmware routines to evaluate sensed signals and generate switching commands. In this case, the control logic 110 may be realized in software, while the current sense input 104 and optional feedback interface 106 may be connected to integrated analog-to-digital (AD) converters within the microcontroller. The drive output 102 may be provided through a general-purpose output pin or a dedicated PWM output stage. In other embodiments, the controller 100 may also form part of a larger system-on-chip (SoC), where it may be embedded alongside other control and communication functions. The controller 100 may be configured to operate in low-power environments and to meet the specific timing and responsiveness requirements of burst mode operation in switching power converters.

The drive output 102 is configured to provide a control signal to a power switch of the switching power converter. This signal may determine the on-time and off-time of the switch during each switching cycle, and may thereby control the energy transferred from the input to the output of the converter. The drive output 102 may generate a pulse-width modulated (PWM) signal or another type of switching waveform, depending on the control strategy implemented by the controller 100. The signal at the drive output 102 may be synchronized with internal timing or current feedback mechanisms and may be influenced by decisions made within the control logic 110. In an example implementation, the drive output 102 may include level-shifting or gate-driving circuitry, enabling it to directly interface with and drive external power transistors such as MOSFETs or IGBTs as power switches. The characteristics of the drive output 102, including voltage levels, rise and fall times, and drive strength, may be selected to match the requirements of the specific power switch and ensure efficient and reliable switching performance.

The current sense input 104 is configured to receive a signal that is indicative of the current flowing through the power switch of the switching power converter. This signal may originate from a current sensing element such as a shunt resistor, a current transformer, or a dedicated current sensor placed in a conduction path of the switch. The current sense input 104 may provide this signal to the control logic 110, where it may be used to implement current-based control strategies, such as peak current mode control or overcurrent protection. The signal received at the current sense input 104 may be subject to transient effects, particularly during the initial switching cycles following a burst idle period, and these effects may be suppressed or filtered by techniques such as leading-edge blanking (LEB). In some implementations, the current sense input 104 may include analog filtering or signal conditioning stages to ensure signal integrity before the current information is processed by the controller 100. Timing and magnitude of the sensed current may influence the duration of the drive signal at the drive output 102 and play a role in regulating energy transfer and ensuring safe operation of the power converter.

The control logic 110 is configured to process input signals, such as the current sense signal and optionally one or more feedback signals, and to generate appropriate control actions for operating the switching power converter. It may evaluate whether the converter is transitioning from a burst idle state (period of inactivity between two consecutive bursts within burst mode operation) to an active burst state (period during which the controller 100 resumes switching activity after a burst idle period) and, in response to detecting such a transition, may modify the switching behavior to ensure stable and reliable operation during the wake-up phase. Specifically, the control logic 110 may be configured to extend a LEB interval (an extended LEB interval is a temporarily increased duration during which the current sense signal is masked or ignored after the turn-on of the power switch) and/or to apply a fixed on-time during one or more initial switching cycles following the transition. The control logic 110 may also determine when to revert to standard current-based switching control, based on conditions such as elapsed time, number of burst pulses, or the controller's supply voltage level. The control logic 110 may include state machines, timers, comparators, or processing units that coordinate the control tasks and ensure that switching decisions are made in accordance with predefined timing and safety constraints. In a microcontroller-based implementation, the control logic 110 may be realized in software or firmware, allowing for flexible configuration and adaptation to different power converter designs and operating conditions. Through its operation, the control logic 110 may enable efficient burst mode control while safeguarding against undesirable transients and ensuring reliable system behavior.

The at least one optional feedback interface 106 is configured to receive a signal that may be indicative of a system-level parameter, such as an output voltage of the power converter or a voltage sensed at an auxiliary winding of the transformer. This signal may provide information about the load condition or the regulation state of the converter and may be used by the control logic 110 to adapt burst mode parameters accordingly. For example, based on the feedback signal, the control logic 110 may vary a number of switching pulses within a burst (of pulses), adjust the on-time of individual pulses, or modify a pause duration between consecutive bursts. The feedback interface 106 may include circuitry for signal scaling, filtering, or analog-to-digital conversion, depending on whether the feedback is processed in analog or digital form. In some implementations, the feedback signal may serve as an input to regulation loops or may contribute to decisions regarding burst termination or a resumption of switching activity. Although not essential to basic burst mode operation, the feedback interface 106 may enhance performance by enabling closed-loop control and improving the converter's ability to respond to changing load or supply conditions. Through its interaction with the control logic 110, the feedback interface 106 may help maintain output stability, reduce ripple, and optimize overall power conversion efficiency.

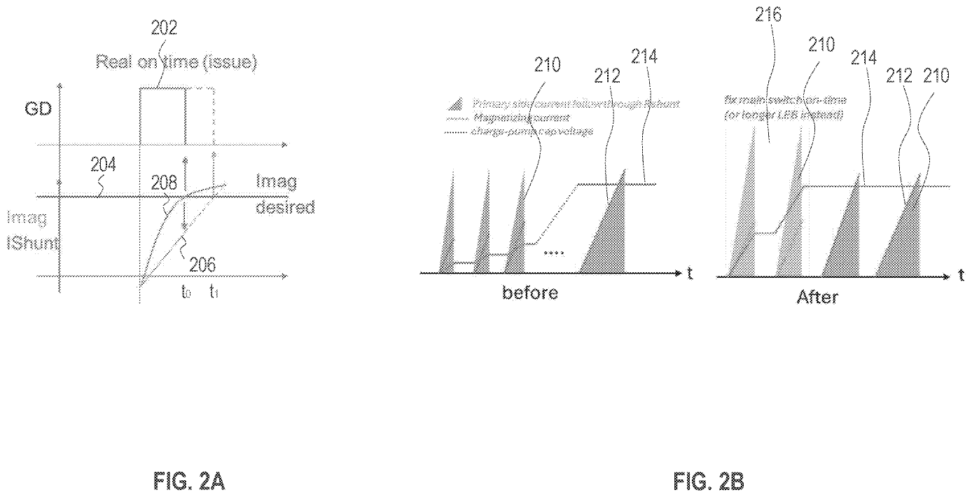

FIG. 2A illustrates a timing and current waveform diagram that highlights a problem occurring during the wake-up phase of a switching power converter operating in burst mode. The vertical axis represents signal levels, while the horizontal axis represents time. The top waveform 202, labeled “GD,” corresponds to a gate drive signal generated by the controller 100 at drive output 102 to turn on the power switch. The duration of this signal defines the on-time of the switch.

Below the GD signal 202, two current waveforms are shown: a desired magnetizing current 204, labeled “Imag desired”, and two actual current traces: “Imag” 206 and “IShunt” 208. The curve 206 represents an expected or ideal magnetizing current buildup in the transformer, while the curve 208 shows an actual current sensed at current sense input 104 (e.g., via a shunt resistor) during a first switching pulse after wake-up.

Due to the presence of inrush current from an uncharged charge-pump capacitor, the sensed current IShunt 208 may rise more rapidly and reach the peak current threshold 204 earlier (at t₀) than expected (at t₁). As a result, the switch is turned off prematurely, leading to a shortened “real on time”. This premature switch-off prevents the magnetizing current 206 from reaching the desired level, resulting in insufficient energy transfer and a disruption in the intended burst mode operation.

FIG. 2A relates to the problem addressed by the present disclosure. Specifically, it illustrates the challenge of transient inrush currents interfering with current sense feedback during initial cycles after a burst idle period. The premature turn-off triggered by these transient conditions leads to ineffective energy delivery and may result in repeated retries, increased burst pulse counts, or unstable converter behavior. The present disclosure addresses this issue by proposing techniques such as extending the LEB interval and/or temporarily fixing the on-time during these critical cycles. These measures can suppress the effect of the inrush current or bypass current-based control altogether, thereby allowing the magnetizing 206 current to reach its desired level and ensuring a smooth and stable wake-up sequence in burst mode.

To solve the above problem, some embodiments of the present disclosure proposes a dynamic adjustment to the current-control mechanism during burst mode wake-up. Specifically, when the controller 100 transitions from a pause (no switching) to an active burst, it may temporarily extend the LEB period or otherwise ignore the current-sense limit 204 for the first few switching cycles. The LEB is a short interval after a switch turns on during which the current feedback at current sense input 104 is masked to avoid false tripping from switching noise. In normal operation this blanking time is very brief (just enough to filter spurious spikes). The present disclosure proposes that on a burst restart, the controller 100 uses an extended LEB—essentially blanking out a larger portion of the initial current spike coming from the charge-pump capacitor. Because the current sense comparator is blind for this slightly longer interval, the inrush current does not prematurely terminate the pulse. This allows the switch on-time to reach a level needed to deliver more energy to both the output and the V_{CC} supply. After a predetermined condition is met—for example, after a certain number of pulses or a short time—the LEB may be restored to its normal value, and the controller 100 may resume standard peak-current mode control.

FIG. 2B illustrates a comparison between the behavior of the switching power converter before and after applying the solution proposed in the present disclosure. The horizontal axis represents time, while the vertical axis reflects current and voltage levels. On both sides of FIG. 2B, areas 210 represent a primary side current sensed through a shunt resistor, dashed lines 212 show the magnetizing current buildup, and lines 214 indicate a voltage across a charge-pump capacitor that supplies the controller 100.

In the “before” scenario shown on the left, each switching cycle following a burst idle period (period of inactivity between two consecutive bursts within burst mode operation) exhibits premature termination of the switch-on phase. This is caused by the inrush current drawn by the uncharged charge-pump capacitor, which distorts the current sensed (e.g., through a shunt resistor). As a result, the controller 100 detects an overcurrent condition and turns off the switch too early. The magnetizing current does not reach its desired level, and the energy transferred during each pulse is insufficient to charge the capacitor effectively. This leads to an increased number of burst pulses and prolonged recovery of the internal supply, as indicated by the gradual and delayed ramp-up of the capacitor voltage.

In contrast, the “after” scenario on the right illustrates the effect of applying measures proposed in the present disclosure. During the initial switching cycles after the burst idle state, indicated by 216, the controller 100 may apply a fixed on-time and/or extend the LEB interval. These techniques suppress or ignore the inrush-related disturbances that would otherwise cause early switch-off. As a result, the magnetizing current is allowed to rise as intended, leading to a more complete energy transfer during each pulse. The charge-pump capacitor reaches its target voltage within fewer switching cycles, and the converter stabilizes more quickly. This behavior reduces power losses and improves efficiency in burst mode operation.

FIG. 2B thus demonstrates how the selective or combined application of fixed on-time and extended LEB may improve the robustness and effectiveness of the converter during wake-up, directly addressing the inrush current problem identified in the prior art.

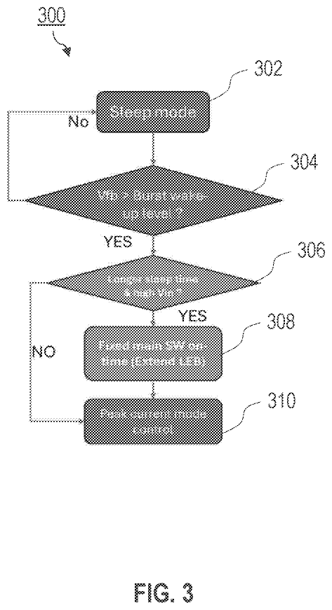

Method 300 illustrated in FIG. 3 describes a process for controlling a power converter in burst mode according to embodiments.

Method 300 begins in a sleep period of the power converter, represented by step 302. During this phase, no switching activity takes place, and the controller 100 monitors for a wake-up condition. Sleep period refers to a continuous time interval during which the switching element remains off and the controller 100 does not generate switching pulses. In the context of burst mode, the sleep period may overlap with or be equivalent to the burst idle state. However, the sleep period may also include extended durations of inactivity beyond regular burst intervals, for example, in standby or ultra-low-power modes.

At step 304, the method 300 includes evaluating whether a feedback voltage Vfb has exceeded a predefined burst wake-up threshold level. This wake-up condition refers to a condition detected by the controller 100 that triggers the transition from the burst idle state or sleep period to the burst active state. The wake-up condition may be based on one or more criteria, such as a feedback voltage (Vfb) falling below a threshold, a controller supply voltage dropping below a level, an elapsed sleep time exceeding a predefined duration, or a combination thereof. The feedback voltage Vfb may be received via the feedback interface 106 of the controller 100. The feedback interface 106 is configured to acquire a signal indicative of the output voltage or an auxiliary winding voltage of the power converter, for example. This signal may be used by the control logic 110 to determine whether the load or output conditions require reactivation of the switching operation. If the feedback signal indicates that the output has dropped below a certain level, burst operation is initiated. Conversely, if the threshold is not exceeded, indicating that no immediate switching is required, the method returns to the sleep mode in step 302.

If the feedback signal received via the feedback interface 106 indicates that burst mode should resume, the method 300 proceeds to step 306, where the controller 100 determines whether the sleep time was sufficiently long and whether the controller supply voltage Vin is high. These conditions may serve as indicators of a wake-up situation in which the charge-pump circuit remains in an uncharged or only partially charged state.

To determine the duration of the sleep period, the controller 100 may include an internal timing mechanism, implemented within the control logic 110, that may measure the time elapsed since the last active burst cycle. This timing information enables the control logic 110 to assess whether the duration of the burst idle state exceeds a defined threshold. In parallel, the controller 100 may be equipped with a voltage sensing input (e.g., interface 106) configured to monitor the controller supply voltage Vin of the power converter. This input may be realized as part of an analog interface, optionally including filtering and analog-to-digital conversion circuitry, which provides the control logic 110 with information on the present input voltage level.

By evaluating the combination of sleep time and input voltage conditions, the control logic 110 may infer whether the internal charge-pump supply may still be in a state where inrush current is expected during the first switching cycles. This assessment may allow the controller 100 to initiate transient-handling measures, such as fixed on-time control and/or extended LEB, during the wake-up phase in order to ensure stable burst mode reactivation.

In response to identifying such a wake-up condition, the method proceeds to step 308. Specifically, the control logic 110 may fix the on-time of the switching element for one or more switching cycles and/or extend a LEB interval applied to the sense signal. This intervention is intended to mask the transient inrush current associated with the initial charging of the charge-pump capacitor, thereby preventing premature termination of the switch-on phase.

To fix the on-time of the switching element, the controller 100 may include a timer or minimum on-time circuit that is capable of overriding the current sense signal during the initial switching cycles. This timer may be part of the control logic 110 and may be used to enforce a predetermined on-time regardless of the current sensed at the current sense input 104. Such a fixed on-time may ensure that the switch remains on long enough to support adequate energy transfer, even if the sensed current is distorted due to inrush effects from a discharged charge-pump capacitor.

Alternatively, or additionally, the control logic 110 may be configured to apply an extended LEB interval to the current sense signal. A corresponding circuit may be integrated into or functionally associated with the current sense input 104. During normal operation, a default LEB interval may be applied upon each turn-on of the power switch to suppress short-duration switching noise. In the wake-up scenario, the control logic 110 may temporarily override the default LEB timer with an extended LEB. This may prevent the inrush current from prematurely triggering the peak current threshold, thereby avoiding undesired early termination of the switch-on phase.

Under normal operating conditions, the controller 300 may apply a default LEB interval of e.g. 300 nanoseconds after each turn-on of the power switch. This interval is sufficient to suppress short-duration switching transients and ensures that the current sense input 104 receives a clean and meaningful signal for peak current detection. However, during the initial switching cycles following a sleep period, the situation is markedly different. The inrush current caused by the charging of the supply capacitor in the charge-pump circuit may persist for several microseconds. If this transient current is not suppressed, it may cause the current sense input 104 to reach the peak current threshold prematurely, resulting in early termination of the switch-on interval and unstable converter behavior.

To prevent this, the control logic 110 may override the default LEB interval and apply an extended LEB interval, for example, lasting 3 microseconds. This extended blanking interval is applied only during the first few switching cycles after wake-up, during which the charge-pump capacitor is not yet fully charged. During this time, the current sense signal is effectively ignored, allowing the switch to remain on long enough for the inrush current to subside and for sufficient energy to be transferred to the output and to the internal supply rail.

Following this transient-handling phase, the method advances to step 310, where it reverts to peak current mode control. At this point, the extended LEB or fixed on-time is no longer applied, and normal current-based switching operation resumes. In peak current mode control, the controller 100 may regulate the energy delivered to the output by terminating each switching cycle when the current through the main switching element reaches a predetermined peak value.

Peak current mode control may be implemented by continuously monitoring the current through the power switch via the current sense input 104. This sensed current signal may be compared to a reference threshold, which may be determined based on output voltage regulation requirements or feedback signals received through the optional feedback interface 106. When the sensed current reaches the threshold, the control logic 110 may instruct the drive output 102 to turn off the switch, thereby ending the conduction phase of the switching cycle. This mode of control allows for cycle-by-cycle current limiting, which improves protection and enhances control accuracy, especially under varying load conditions. Additionally, peak current mode control may inherently respond to changes in input voltage and load, making it suitable for dynamic applications. It may also simplify the compensation of the control loop compared to voltage mode control, due to its inner current loop which effectively linearizes the converter's response.

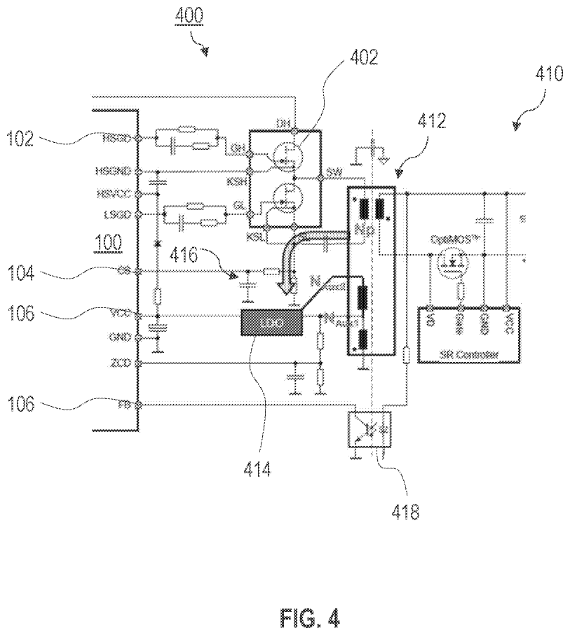

FIG. 4 illustrates a circuit diagram of an apparatus 400 for controlling a power converter 410. The figure shows an interconnection of various functional blocks and circuit elements, including a controller 100, a switching element 402, a transformer 412 with a primary winding Nₚ and auxiliary windings N_{AUX1} and N_{AUX2}, a charge-pump circuit 414, and a current sensing arrangement 416. The apparatus 400 is configured to operate the power converter 410, which includes secondary-side components such as a synchronous rectification (SR) stage and an SR controller.

The controller 100 includes external terminals such as drive output 102, current sense input 104, and feedback interface 106. These terminals correspond to the previously described functional blocks responsible for driving the switching element 402, monitoring current through a sensing network, and processing a feedback signal representative of output or auxiliary winding voltage.

The switching element 402 is connected in series with the primary winding Nₚ of the transformer 412. It comprises a configuration including high-side and low-side MOSFETs, driven via signals provided through gate drive circuits that are connected to the controller 100 via the drive output 102. The transformer 412 includes two auxiliary windings, N_{AUX1} and N_{AUX2}, which are magnetically coupled to the primary winding Nₚ. These auxiliary windings serve multiple functions, including supporting the generation of a controller supply voltage and enabling feedback and zero-crossing detection.

In the circuit shown in FIG. 4, the primary winding Nₚ of the transformer 412 is connected between to a switching node SW. The switching node SW is formed by the connection point between the high-side and low-side MOSFETs. The high-side MOSFET is connected between a positive input supply and the switching node SW, while the low-side MOSFET is connected between the switching node SW and ground. When the high-side MOSFET is turned on, current flows from the input supply through the high-side MOSFET and into the upper terminal of the primary winding Nₚ. This initiates the magnetizing current in the transformer and transfers energy into the magnetic core. When the low-side MOSFET is turned on instead, the switching node is pulled to ground, allowing current to flow through the transformer winding in the opposite direction or enabling the transformer to reset depending on the converter topology.

The gate signals that control the turn-on and turn-off of the high-side and low-side MOSFETs are generated by the controller 100 and delivered via the drive output 102, which interfaces with the corresponding gate driver circuitry. This drive signal generation is managed by the internal control logic 110 of the controller 100, based on operating mode, sensed signals, and timing requirements. The connection of the primary winding Nₚ to the switching node SW ensures that the voltage applied across the winding alternates according to the switching pattern, enabling the transformer 412 to perform energy transfer and voltage conversion as required by the power converter 410.

The charge-pump circuit 414 is coupled to one or both of the auxiliary windings N_{AUX1}, N_{AUX2} and is configured to generate a supply voltage V_{CC} for the controller 100 during burst mode operation, when the main energy path is inactive. The charge-pump circuit 414 includes one or more capacitors and diodes and may charge a supply capacitor, whose voltage is regulated via an internal or external low-dropout (LDO) regulator. The controller 100 uses this supply voltage V_{CC} to power internal logic, including the control logic 110 that implements burst mode control. If the charge-pump capacitor is not sufficiently charged after a sleep period, the controller 100 may detect this condition as part of a wake-up routine.

In the circuit shown in FIG. 4, the current sensing arrangement 416 is implemented as a resistive sensing path positioned in series with the return path of the primary winding Nₚ of the transformer 412. More specifically, the current sensing resistor is located between the source terminal of the low-side MOSFET—labeled SL (source low)—and ground. The upper end of the primary winding Nₚ is connected to the switching node SW, which in turn connects to the drain of the low-side MOSFET. When the low-side MOSFET is conducting, current flows from the supply rail through the high-side MOSFET or the transformer, through the low-side MOSFET, and finally through the current sensing resistor in arrangement 416 to ground.

The voltage drop across the sensing resistor, which is proportional to the instantaneous current flowing through the primary winding and the low-side switch, is routed to the current sense input 104 (pin CS) of the controller 100. This voltage represents the sensed current signal and is used by the controller's internal control logic 110 to perform peak current mode control. The signal at pin 104 may be internally compared to a programmable or predefined threshold to determine when the switch should be turned off. To improve reliability and noise immunity, the sensed signal may be processed through filtering or subjected to a leading-edge blanking interval that suppresses switching transients immediately following turn-on. In this configuration, the current sensing arrangement 416 provides the controller 100 with accurate real-time information about the current flowing through the power stage, enabling precise and responsive current-mode regulation.

In the circuit of FIG. 4, the LDO, which forms part of the charge-pump circuit 414, is used to generate the supply voltage V_{CC} for the controller 100. The LDO 414 is connected between the auxiliary windings N_{AUX1} and N_{AUX2} of the transformer 412 and the V_{CC} supply pin 106 of the controller 100.

The auxiliary windings N_{AUX1} and N_{AUX2} are magnetically coupled to the primary winding Nₚ and are positioned on the primary side of the transformer core. These windings produce a voltage during specific switching intervals, corresponding to the transformer's operating cycle. The rectified and filtered voltage from these windings provides the raw supply input to the LDO 414.

N_{AUX1} may provide the main energy delivery path to the LDO input during a flyback phase, when energy stored in the transformer core is transferred to the secondary side. N_{AUX2} may support additional charge-pump boosting or serve as a zero-crossing detection input. The voltage generated across these windings may be rectified using diodes and smoothed using filter capacitors before being fed into the input of the LDO 414.

The output of the LDO 414 is connected to pin 106 (V_{CC}) of the controller 100. The LDO regulates the varying input voltage derived from the auxiliary windings to provide a stable and continuous supply voltage for the internal circuitry of the controller 100, including the control logic 110, drive output 102, and sensing interfaces. During burst mode wake-up, when the auxiliary winding voltage may be low or absent, the charge-pump behavior and inrush charging of associated capacitors become critical, and the controller may apply adaptive blanking or fixed on-time to ensure proper recharging of the V_{CC} rail through the LDO 414.

In operation, the controller 100 may monitor V_{CC} and the current sense signal to decide when to initiate burst switching cycles. Following a burst idle period, the controller 100 may detect whether the wake-up condition is met by evaluating internal supply voltage levels and optionally the discharge state of a capacitor within the charge-pump circuit 414. If the supply is not sufficiently charged, the controller 100 may respond by applying a fixed on-time to the switching element 402 or extending a LEB interval at the current sense input 104. This prevents premature termination of the initial switching pulses and allows the charge-pump circuit 414 to restore the controller's supply voltage more effectively. Once the internal supply has stabilized, the controller 100 reverts to peak current mode control, during which each switching cycle is terminated based on the sensed current through the current sensing arrangement 416.

FIG. 4 also shows a photocoupler (also known as an optocoupler) 418, which may be used for galvanic isolation in power supply feedback loops. A LED inside the optocoupler is driven by the secondary side of the power converter 410—e.g., via voltage reference circuit—and its output transistor (on the primary side) connects to another feedback pin 106 (FB) of the controller.

This configuration allows the output voltage of the converter to be monitored indirectly. If the output voltage rises or falls, the current through the optocoupler's LED changes, modifying the voltage at the FB pin. The controller 100 may use this signal—received via the feedback interface 106—to adjust switching behavior, such as burst entry or exit conditions, pulse count, or duty cycle.

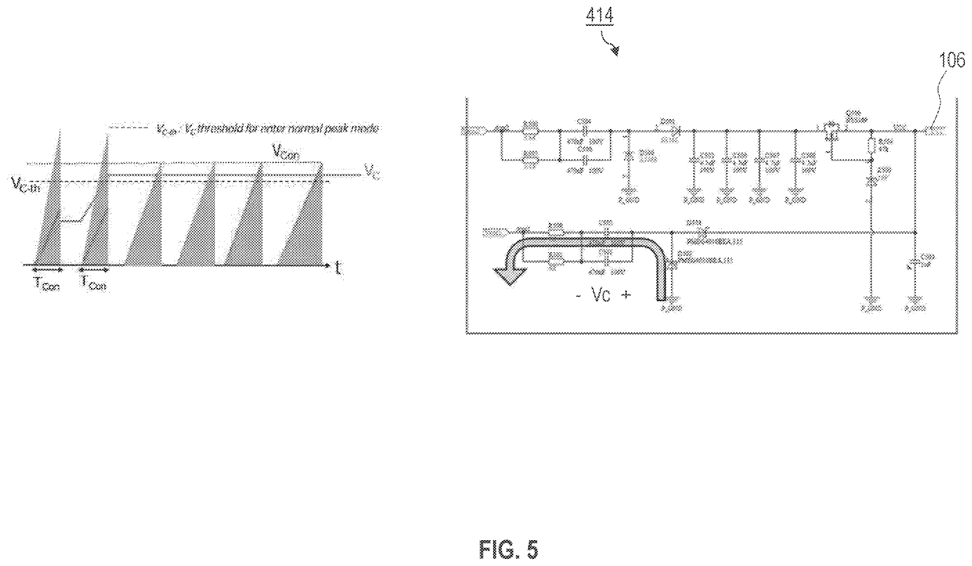

FIG. 5 provides a more detailed schematic view of the charge-pump circuit 414 and its interaction with the feedback path 106, complementing the higher-level architecture shown in FIG. 4. It focuses on the part of the system responsible for generating the controller supply voltage (V_{CC}) and highlights how the initial charging behavior of the charge-pump capacitors can influence the sensed current signal and thereby affect pulse-width modulation (PWM)

### Current Mode Control.

The charge-pump circuit 414 is used to supply the controller 100 during burst mode. FIG. 5 zooms into corresponding circuitry and shows how the energy from the auxiliary windings (labeled AUX1 and AUX2) may be rectified and filtered to generate a DC supply voltage. Capacitors C504, C500, and C505, in combination with diodes D500-D503 and resistors such as R500 and R501, form the charge-pump and rectification network. These components collect energy from the auxiliary windings and store it in a capacitor bank composed of several filter and bulk capacitors (C502, C506, C507, etc.).

FIG. 5 highlights the interaction between the inrush charging current flowing into the capacitors and the current sensed by the controller 100. As shown by the arrow, the charging current—especially after a burst idle phase when the capacitors are partially or fully discharged—flows through the current sense path and introduces a transient that may be misinterpreted by the controller 100 as a legitimate load current. This can result in premature termination of the switch-on interval due to false overcurrent detection.

This phenomenon directly relates to the function of the current sensing arrangement 416 in FIG. 4, which connects to the current sense input 104 of the controller 100. If the sensed current includes a component caused by capacitor charging (rather than load demand), the controller 100 may fail to deliver sufficient energy during the initial pulses of the burst cycle. This justifies the need for the measures proposed in the present disclosure, such as temporarily fixing the on-time and/or extending the leading-edge blanking interval to mask the effect of this charging current.

Furthermore, the charge-pump circuit 414 in FIG. 5 also connects to the feedback interface 106, as the voltage V_{CC}—visible on the right side—is regulated and used as an indicator of whether sufficient internal supply is available. If V_{CC} is below a required threshold, the controller 100 may delay the reversion to peak current mode control.

The skilled person having benefit from the present disclosure will appreciate possible limitations of using a fixed or constant on-time (T_{Con}) during the initial switching cycles following a burst idle phase. In this case, the drive output 102 maintains the power switch 402 in the on-state for a fixed time, regardless of the current measured at the current sense input 104. However, due to the presence of transient inrush current—primarily caused by the charging of the supply capacitor in the charge-pump circuit 414—the real peak current may not reach a desired peak current command level (V_{Con}). As a result, the converter may operate inefficiently, and peak current mode control cannot be resumed reliably. This illustrates that control logic 110 within the controller 100 may require more than fixed timing to ensure proper regulation during burst mode wake-up.

The present disclosure proposes to expand on this by introducing a control scheme where the controller 100 uses direct or indirect monitoring of the supply voltage V_{CC} generated by the charge-pump circuit 414. This monitoring may be performed internally by the control logic 110 or via an analog input coupled to the feedback interface 106. Until V_{CC} exceeds a defined threshold, which indicates that the controller's internal supply is sufficiently charged, the control logic 110 may continue to apply a fixed on-time or extended LEB to suppress the effect of inrush current reflected through the current sense input 104. Once the threshold is crossed, indicating stable operation, the controller 100 may transition back to peak current mode control. This illustrates the controller's ability to adapt its operation based on internal supply conditions rather than relying solely on current feedback.

The present disclosure also proposes a combined control strategy that integrates emulated magnetizing current estimation with peak current control. In this implementation, the control logic 110 within the controller 100 may calculate an appropriate on-time based on transformer parameters such as a transformer winding voltage (V_{T}) and a primary inductance (Lₚ). These parameters may be obtained using the auxiliary winding coupled to the transformer 412, and the resulting estimation may be used to set the pulse width at the drive output 102. This allows the controller 100 to regulate the magnetizing current, (i_{Mag}), even in the absence of accurate feedback from the current sense input 104 during the initial wake-up cycles. Once the sensed current signal stabilizes and matches the expected behavior, the control logic 110 may resume conventional peak current mode control. This hybrid strategy may ensure continuous regulation and avoids premature switch-off caused by distorted current signals.

In a more advanced sensing technique, the control logic 110 may compare the signal received at the current sense input 104 (V_{CS}) with an emulated current reference representing the ideal magnetizing current. The difference (ΔV_{CS}) may be interpreted by the control logic 110 as an indication of inrush current flowing into the charge-pump capacitor within circuit 414. When this deviation exceeds a defined margin, the controller 100 may identify a wake-up condition and activate suppression techniques such as extending the LEB interval or maintaining a fixed on-time at the drive output 102. As the capacitor charges and ΔV_{CS} decreases, the sensed current converges toward the emulated i_{Mag}, and the control logic 110 may transition the system back to current-based control. This capability of identifying and responding to inrush-specific current behavior demonstrates the intelligent, condition-aware nature of the disclosed system.

The present disclosure describes a two-phase burst operation implemented by the controller 100 to improve burst mode wake-up behavior in a switching power converter. The operation may begin with an inrush accommodation phase, during which the control logic 110 temporarily modifies the converter's switching behavior to suppress the influence of inrush current caused by charging the supply capacitor in the charge-pump circuit 414. This may be followed by a normal regulation phase, where the controller resumes standard peak current mode control using the current sense input 104.

During the initial phase, the control logic 110 may extend the leading-edge blanking (LEB) interval and/or fix the on-time of the switching element 402 at the drive output 102. The extended LEB prevents inrush current from prematurely triggering the peak current comparator, while fixed on-time bypasses the current comparator altogether. This allows the charge-pump capacitor to charge without tripping protection mechanisms, reduces the number of switching pulses required during burst wake-up, and minimizes the duration of the burst active period. These improvements may lead to lower standby input power and more stable startup behavior.

A preferred embodiment involves programming the internal LEB circuit of the controller 100 to apply a longer blanking duration to the current sense input 104 for the first one or more switching cycles after exiting sleep mode. For example, if the default LEB is 200 ns, the control logic 110 may temporarily override this with an extended blanking time in the range of microseconds. After a predefined number of switching pulses—such as two or three—or after a defined time interval, the LEB may revert automatically to its default duration. This strategy allows the first few pulses to ignore misleading current feedback caused by inrush charging while maintaining a fallback peak current limit for safety.

An alternative embodiment replaces extended LEB with a fixed on-time strategy, where the controller 100 may hold the power switch 402 on for a preset duration during the first burst pulses, regardless of the current sense signal at input 104. This may guarantee a minimum energy per pulse and effectively replicates the purpose of extended blanking. This method demonstrated similar benefits in reducing pulse count and standby power. However, it was also noted that if the fixed on-time is not adaptive, it may result in inconsistent peak current levels under different input voltage conditions.

Thus, the present disclosure further considers adaptive control schemes, where the duration of extended blanking or fixed on-time is made dependent on system conditions. The control logic 110 may evaluate the V_{CC} supply voltage of the controller 100—monitored via the charge-pump circuit 414—or assess the duration of the preceding sleep period. For longer idle periods (when the charge-pump capacitor is likely discharged), the controller 100 may apply extended blanking or fixed on-time for more cycles. For shorter idle durations or when the V_{CC} voltage is above a defined threshold, the controller may apply fewer or no additional cycles. The feedback interface 106 may be used to further inform this decision, for example by monitoring auxiliary winding voltage or output feedback to assess system readiness.

An additional variant may involve partially pre-charging the V_{CC} capacitor before burst restart using a bias source or trickle current, although this may involve additional external circuitry and diverges from the otherwise firmware-based solution.

In essence, the present disclosure covers any implementation where, during burst mode wake-up, the current-limiting behavior of the controller 100 is temporarily relaxed until the supply voltage generated by the charge-pump circuit 414 stabilizes. The different embodiments—ranging from fixed pulse-count-based schemes to conditionally adaptive control based on V_{CC} or output feedback—are all aimed at achieving stable wake-up with fewer pulses, reduced standby power, and no need for external components. These techniques are implemented entirely within the control logic 110 and firmware of the controller 100, making the solution efficient, low-cost, and scalable.

In addition to the use of fixed on-time control and/or extended LEB for suppressing inrush-related current effects, alternative or additional approaches may also be used to ensure stable burst mode wake-up. These implementations may allow a broader range of system designs, potentially improving flexibility, performance, or cost-efficiency.

One alternative comprises direct sensing of an auxiliary supply voltage (Vc) (see FIG. 5). In this variant, the controller 100 may monitor whether a voltage—e.g., across a V_{CC} or auxiliary capacitor—has reached a predefined threshold (VC-th). The controller 100 may suppress peak current control (e.g., via LEB extension or fixed on-time) until this voltage exceeds the threshold. This may ensure that peak current detection is only resumed once the internal supply is sufficiently charged.

Another embodiment implements emulation of the magnetizing current (i_{Mag}) flowing through the transformer primary. The controller 100 may estimate i_{Mag} based on known transformer parameters such as winding voltage (V_{T}) and primary inductance (Lₚ), e.g., via: i_{Mag}=V_{T}/Lₚ·Tₒₙ. Here, V_{T} may be derived from an auxiliary winding voltage while the main switch is on. This allows the controller 100 to determine an expected current evolution without relying on a potentially distorted sensed signal.

In yet another variant, the sensed current (at 104) may be compared with the emulated i_{Mag}. A deviation (ΔV_{cs}) between measured and expected current can be used to infer inrush effects. If this deviation exceeds a margin, the controller 100 may suppress peak current cutoff or enforce a fixed on-time. Once the deviation falls below the margin, normal peak current control may resume. This hybrid technique may help distinguish inrush artifacts from legitimate current signals.

Any of these methods may be used alone or in combination with fixed on-time and/or LEB extension.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A controller for operating a switching power converter, the controller comprising:
a drive output configured to drive a power switch of the switching power converter;
a current sense input configured to receive a current sense signal indicative of a current through the power switch; and
control logic configured to:
detect a transition from a burst idle state to an active burst state of the switching power converter; and
in response to the transition, at least one of:
extend a leading-edge blanking (LEB) interval applied to the current sense signal for one or more switching cycles before reverting to a default LEB interval; or
fix an on-time of the power switch for one or more switching cycles.

2. The controller of claim 1, wherein the control logic is configured to detect the transition based on at least one of:
a duration of a preceding burst idle state;
a measured supply voltage of the controller being below a threshold; or
a predetermined time-out.

3. The controller of claim 1, wherein the control logic is configured to revert from the extended LEB interval or the fixed on-time to a peak current-based switching control at least one of after a predetermined number of burst pulses, after a predetermined duration has elapsed, or once a controller supply voltage exceeds a threshold.

4. The controller of claim 1, wherein the control logic is configured to:
apply a first LEB interval to the current sense signal upon turn-on of the power switch,
wherein the control logic comprises a timer that defines the first LEB interval, and an extended LEB interval is set by overriding the timer with a second, longer blanking value in response to the transition.

5. The controller of claim 1, wherein the current sense input is configured to receive an inrush current drawn from a charge-pump supply circuit powering the controller, and the extended LEB interval masks this inrush current from the current sense input during the one or more switching cycles.

6. The controller of claim 1, wherein the control logic is configured, in response to the transition, to maintain the power switch on for at least a set duration regardless of the current sense signal.

7. The controller of claim 1, wherein the control logic is configured to adapt the fixed on-time based on a measured input voltage or a supply voltage of the controller, causing a longer on-time applied under lower voltage conditions.

8. The controller of claim 1, further comprising a feedback interface configured to receive a feedback signal indicative of an output voltage or an auxiliary winding voltage, wherein the control logic is configured to vary at least one of a number of pulses in a burst, an on-time of each pulse, or a pause duration between bursts in response to the feedback signal.

9. The controller of claim 1, wherein the control logic is configured to combine an extended LEB interval and fixed on-time within a same wake-up sequence, wherein initial burst pulses utilize a fixed on-time and subsequent burst pulses utilize an extended blanking interval.

10. A method of controlling a power converter, the method comprising:
providing a drive signal for operating a switching element in a burst mode following a sleep period of the power converter;
receiving a sense signal indicative of current flowing through the switching element of the power converter;
monitoring a wake-up condition associated with a charge-pump circuit; and
in response to identifying the wake-up condition, performing at least one of:
extending a leading-edge blanking (LEB) interval applied to the sense signal for one or more switching cycles before reverting to a default LEB interval; or
fixing an on-time of the switching element for one or more switching cycles.

11. The method of claim 10, comprising receiving an inrush current drawn from a charge-pump supply circuit.

12. An apparatus for controlling a power converter, the apparatus comprising:
a transformer having at least one primary winding and at least one auxiliary winding magnetically coupled to the primary winding;
a charge-pump circuit configured to generate a supply voltage for a controller from the auxiliary winding;
a switching element coupled between the controller and the primary winding and configured to selectively enable or interrupt current flow through the primary winding during operation of the power converter;
a current sensing arrangement configured to provide a sense signal representative of a current flowing through the switching element; and
the controller configured to:
operate the switching element in a burst mode after a sleep period;
detect a wake-up condition indicative of the charge-pump circuit being in an uncharged state; and
in response to the wake-up condition, at least one of:
extend a leading-edge blanking (LEB) interval of the current sensing arrangement during one or more switching cycles before reverting to a default LEB interval; or
fix an on-time of the switching element for one or more switching cycles.

13. The apparatus of claim 12, wherein the controller is configured to extend the LEB interval only for a predetermined number of initial switching cycles following the wake-up condition, and to revert to the default LEB interval automatically after the predetermined number of cycles has elapsed.

14. The apparatus of claim 12, wherein the controller is configured to track elapsed time from the wake-up condition and revert to the default LEB interval when either a predefined number of switching cycles or a time threshold is reached.

15. The apparatus of claim 12, wherein the controller is configured to measure the supply voltage associated with the controller, and to extend the LEB interval whenever the supply voltage is below a threshold at the time of the wake-up condition.

16. The apparatus of claim 15, wherein the controller is configured to restore the default LEB interval at least one of once the supply voltage of the controller exceeds the threshold, or after a defined number of switching cycles.

17. The apparatus of claim 12, wherein the controller is configured adapt the fixed on-time based on at least one of:
a measured input voltage to the power converter; or
the supply voltage for the controller indicating a charge level of a supply capacitor, or
an indication of output load conditions.

18. The apparatus of claim 12, wherein the charge-pump circuit comprises at least one capacitor that is at least partially discharged during the sleep period, and the controller is configured to detect a discharge state of said capacitor as part of the wake-up condition.

19. The apparatus of claim 12, wherein the controller is configured to revert from the extended LEB interval or the fixed on-time to a peak current-based switching control at least one of after a predetermined number of burst pulses, after a predetermined duration has elapsed, or once the supply voltage for the controller exceeds a threshold.

20. The apparatus of claim 12, wherein the controller is configured adapt the fixed on-time based on an indication of output load conditions.
